(19) United States
(12) Patent Application Publication
(10) Pub. No.: US 2011/0125902 A1
(43) Pub. Date: May 26, 2011

(54) Apparatus And A Method For Resource Management

(75) Inventors: James Ingham, London (GB); John Forrest, London (GB); Zemaraiam Kinfu, London (GB); Brian Dale Evans, London (GB); Marko Jaakko Hietala, Helsinki (FI); Juha-Pekka Syrjälä, Oulu (FI); Heikki Kujala, Oulu (FI); Janne Juhani Ojanaho, Kempele (FI); Jari Mikael Takalo, Oulu (FI)

(73) Assignee: Nokia Corporation, Espoo (FI)

(21) Appl. No.: 12/624,879

(22) Filed: Nov. 24, 2009

(51) Int. Cl. G06F 15/173

(52) U.S. Cl. 709/226

(57) ABSTRACT

An apparatus and a method are provided with the apparatus being arranged to control access to one or more resources in a computing device by one or more clients in said computing device. The apparatus further arranged to receive a request for access to a said resource from a first client, determine whether or not said resource is being used by a second client, and, if said resource is being used, remove said resource from said second client and provide said resource to said first client. The method and computer program correspond to the apparatus.

### TECHNICAL FIELD

Embodiments of this invention relate to an apparatus and a method for resource management.

### BACKGROUND TO THE INVENTION

A computing device may include many resources. Resources may be hardware (such as memory or an output device) or software (such as a file or graphics algorithm). These resources are shared amongst applications which run on the device and provide a service to those applications. Some resources may be accessed by more than one application. Access to resources must be managed to ensure fair access and to prevent deadlock situations.

### SUMMARY OF EXAMPLES OF THE INVENTION

An example of the invention provides an apparatus comprising: at least one processor; and at least one memory including computer program code, the at least one memory and the computer program code configured to, with the at least one processor, cause the apparatus at least to: control access to one or more resources, by one or more clients; receive a request for access to a said resource from a first client; determine whether or not said resource is being used by a second client; and if said resource is being used, remove said resource from said second client and provide said resource to said first client.

In an example, the at least one memory and the computer program code are further configured to, with the at least one processor, cause the apparatus to: determine if a first condition is met, and to remove said resource from the second client if said first condition is met.

In an example, the at least one memory and the computer program code are further configured to, with the at least one processor, cause the apparatus to: compare a priority of a said first client with a priority of the second, wherein said condition is met if the priority of the first client is at least as great as the priority of the second client.

In an example, said resource is accessed via an interface, and the at least one memory and the computer program code are further configured to, with the at least one processor, cause the apparatus to: remove said resource from said interface between the second client and the resource

In an example, the at least one memory and the computer program code are further configured to, with the at least one processor, cause the apparatus to: allow said second client to continue to use the interface, after said resource has been removed.

In an example, the at least one memory and the computer program code are further configured to, with the at least one processor, cause the apparatus to: notify the second client that the interface should be relinquished.

In an example, the at least one memory and the computer program code are further configured to, with the at least one processor, cause the apparatus to: notify the second client that it should relinquish the resource.

In an example, the at least one memory and the computer program code are further configured to, with the at least one processor, cause the apparatus to: start a timer at the time of notification and at the end of a first time period, remove the resource from the second client, if the second client has not relinquished the resource.

In an example, the at least one memory and the computer program code are further configured to, with the at least one processor, cause the apparatus to: establish a resource management module which is configured to cause the apparatus to operate as described in any preceding claim.

A further example of the invention provides a computing device comprising the apparatus described above. In an example, said device is a mobile phone.

A further example of the invention provides a method comprising: receiving a request from a first client for access to a resource of a computing device; determining if said resource is being used by a second client; removing said resource from said second client if said resource is being used; and providing said resource to said first client.

In an example, removing said resource further comprises determining if a first condition is met, and removing said resource if said first condition is met.

In an example, removing said resource further comprises comparing a priority of a said first client with a priority of the second, wherein said condition is met if the priority of the first client is at least as great as the priority of the second client.

In an example, removing said resource further comprises removing said resource from an interface between the second client and the resource.

In an example, removing said resource further comprises notifying the second client that the interface should be relinquished.

In an example, removing said resource further comprises notifying the second client that it should relinquish the resource.

In an example, removing said resource further comprises starting a timer at the time of notification and at the end of a first time period, removing the resource from the second client, if the second client has not relinquished the resource.

A further example of the invention provides a computer program product comprising a computer-readable medium bearing computer program code embodied therein for use with a computer, the computer program code comprising: code for receiving a request from a first client for access to a resource of a computing device; code for determining if said resource is being used by a second client; code for removing said resource from said second client if said resource is being used; and code for providing said resource to said first client.

A further example of the invention provides a device substantially as described herein and as shown in FIGS. 1 to 9.

A further example of the invention provides an apparatus comprising: means for controlling access to one or more resources, by one or more clients; means for receiving a request for access to a said resource from a first client, means for determining whether or not said resource is being used by a second client, and, if said resource is being used, remove said resource from said second client and provide said resource to said first client.

This summary provides examples of the invention which are not intended to be limiting on the scope of the invention. The features of the invention described above and recited in the claims may be combined in any suitable manner. The combinations described above and recited in the claims are not intended to limit the scope of the invention.

Features and advantages associated with the examples of the invention will be apparent from the following description of some examples of the invention.

### BRIEF DESCRIPTION OF THE DRAWINGS

Examples of the invention are hereinafter described with reference to the accompanying diagrams where:

FIG. 1 is a mobile device in an example of the invention;

FIG. 2 is a schematic diagram showing some components of the device shown in FIG. 1;

FIG. 3 is a functional diagram showing some components of the device shown in FIG. 1;

FIG. 4 is functional diagram showing some components of the device shown in FIG. 1;

FIG. 5 is a flow chart showing a method in an example of the invention;

FIG. 6 is functional diagram showing some components of the device shown in FIG. 1;

FIG. 7 is a flow chart showing a method in an example of the invention;

FIG. 8 is a functional diagram showing some components of the device shown in FIG. 1, in a further example; and

FIG. 9 is a flow chart showing a method in a further example of the invention.

### DESCRIPTION OF EXAMPLES OF THE INVENTION

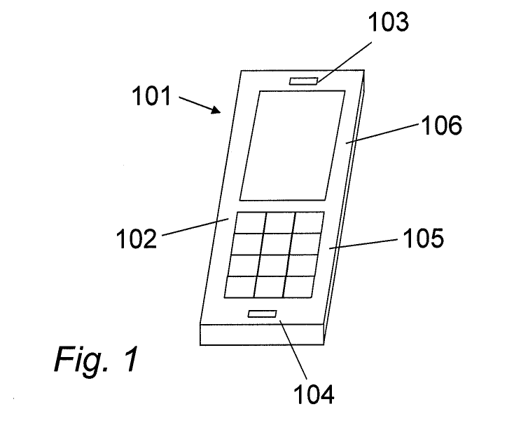

A mobile device 101 in accordance with an example of the invention is shown in FIG. 1. In this example, the mobile device 101 comprises an outer casing 102, which includes an earphone 103 and a microphone 104. In this example, the mobile device 101 also includes a keypad 105 and a display 106. In this example, the keypad 105 enables a user to enter information into the mobile device 101 and instruct the mobile device to perform the various functions which it provides. For example, a user may enter a telephone number, or select another mobile device from a list stored on the mobile device 101, as well as perform functions such as initiating a telephone call.

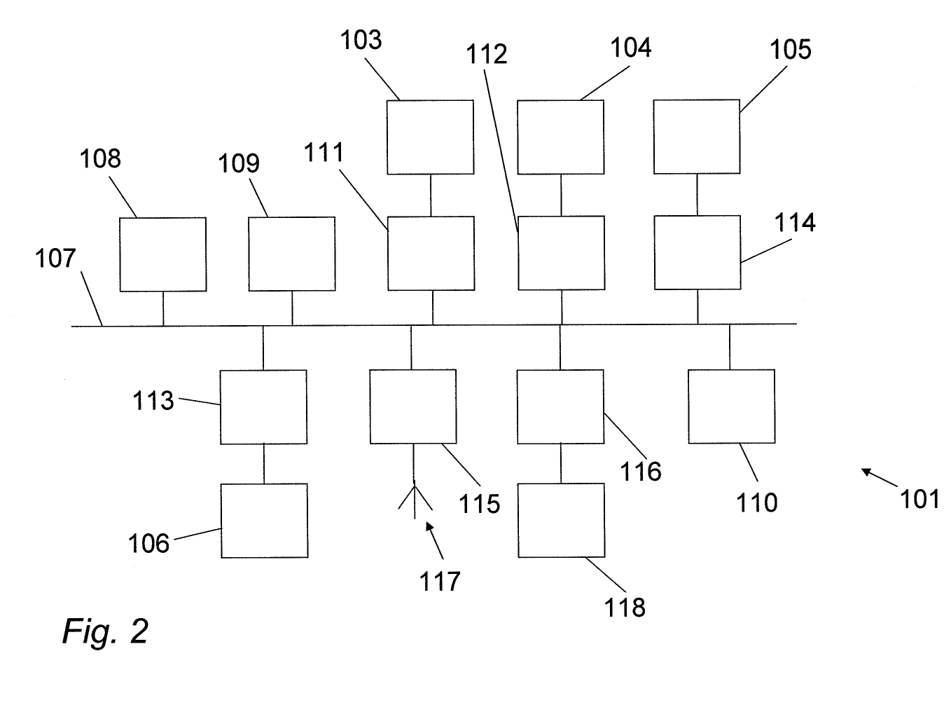

FIG. 2 is a schematic diagram showing the components of the mobile device 101 in this example embodiment. The components of the mobile device 101 may include the earphone 103, the microphone 104, the keypad 105 and the display 106. In this example, the mobile device 101 also includes a system bus 107 to which the components are connected and which allows the components to communicate with each other. In this example, the components are shown to communicate via a single system bus 107. However, in other examples the mobile device may include several buses to connect the various components. In this example, the device also includes an application processor 108, a baseband processor 109, memory 110, an earphone controller 111, a microphone controller 112, a display controller 113, and a keyboard controller 114. In this example, the device 101 also includes a mobile telephone radio 115 and a storage device controller 116. In this example, the application processor 108 is for running an operating system and user applications. In this example, the baseband processor 109 is for controlling a telephony stack. In this example, the mobile telephone radio 115 is also connected to an antenna 117. In this example, the mobile device 101 is arranged to communicate, via radio 117, with a base station of a mobile phone network (not shown). In this example, the storage device controller 116 is connected to a storage device 118 which may be an internal hard drive or a removable storage device such as a flash memory card.

This description of the components of a mobile device is one example of the manner in which the components may be arranged. Many variations are possible including different components and different arrangements of those components. Embodiments of the invention are not limited to any particular set of components nor to any particular combination of those components. Advances in computing device technology may result in certain components being replaced by others which perform the same function. Such a device could also comprise an embodiment of the invention.

In an example embodiment, the mobile device 101 includes an operating system (OS) which is stored in a Read Only Memory (ROM) portion of memory 110. In this example, the device also includes other software applications which may be stored in ROM or which may be stored in the storage device 118. In this example, the application processor 108 is arranged to execute instructions of the OS and of the applications. In this example, execution of these instructions causes mobile device 101 to carry out particular functions by controlling the various hardware components of the device.

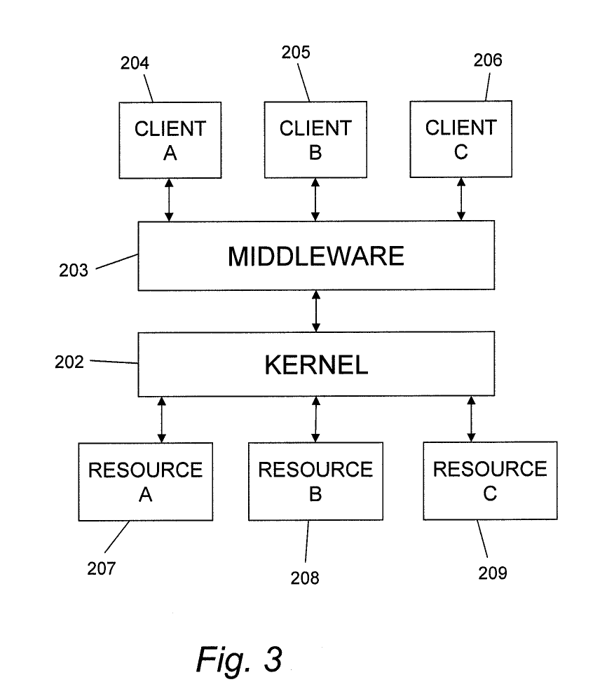

FIG. 3 is a functional diagram showing the logical links between software and hardware components of the device 101 in an example embodiment. In this example, the operating system 201 includes a kernel 202 and a middleware section 203. In this example, the kernel 202 is arranged to manage the mobile device's 101 hardware resources and communications between hardware and software stored on the device. In this example, the middleware 203 controls communication between applications running on the device and the system resources. In this example, the mobile device 101 has a number of applications stored in memory 110 or storage device 118. FIG. 3 shows client A 204, client B 205 and client C 206 in an example embodiment. These clients may be part of the operating system 201 or may be third-party clients. Each of the clients may access computing resources through the middleware section 203. FIG. 3 also show a number of resources in an example embodiment. In this example, resources are hardware or software components to which the clients require access from time to time. FIG. 3 shows resource A 207, resource B 208 and resource C 209 in this example. In this example, the resources are any physical or virtual components of the computing system which has limited availability. In this example, the kernel 203 controls access to the resources.

In an example embodiment, the physical resources of the mobile device 101 include application processor 108, baseband processor 109, the various device controllers mentioned above, memory 110 and the radio 115, amongst others. In this example, virtual resources may include servers of the OS, CODECs, buffers and other multimedia components.

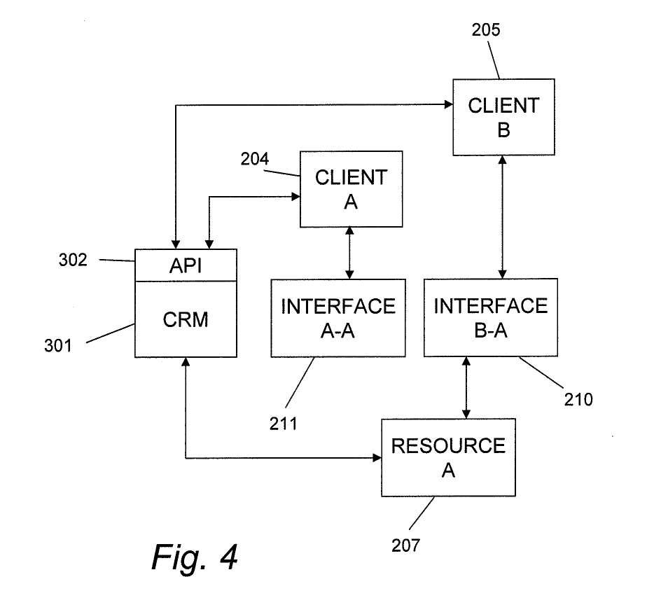

FIG. 4 is a functional diagram of certain components of the mobile device 101 in accordance with an example of the invention. In this example, the device 101 includes a resource management module 301 (which may also be referred to as a centralised resource manager (CRM)) which is provided as part of the middleware 203 of the OS 201. In this example, the resource management module 301 is capable of direct control over certain resources. In this example, the resource management module 301 is a logical entity which is software implemented and which is instantiated when the device is switched on. In a further example, the resource management module 301 may be implemented in hardware. In an example embodiment, the resource management module 301 is arranged to grant or reject requests for access to resources, monitor resource use and to manage queuing of clients in need of a particular resource. In this example, clients access resources indirectly. That is, clients access resources through an abstracted interface. In this example, each abstracted interface mimics the resource itself so that clients think they are accessing the resource directly. In this example, indirect access is controlled by resource management module 301. FIG. 4 shows client A 204 and client B 205, in an example embodiment. In this example, each client is capable of two-way communication with the resource management module 301. In this example, the resource management module 301 includes an Application Programming Interface (API) 302. In this example, access to the resource management module 301 is provided through the API 302. In this example, if a client wishes to access a resource, it may do so by first requesting access from the resource management module 301. An example mechanism by which the resource management module 301 grants or rejects access to a resource is discussed in more detail below. FIG. 4 also shows resource A 207, in an example embodiment. In the example of FIG. 4, client B is shown accessing resource A through abstracted interface B-A 210.

In an example embodiment, if the resource management module 301 decides that a particular client is allowed to access a resource, the resource management module 301 initiates the abstracted interface to that resource. In the above examples, clients access resources through these abstracted interfaces. By providing indirect access in accordance with these examples, a resource can be removed from a client without causing the existing client to crash. In this example, the existing client continues to interface with the abstracted interface. In this example, the existing client is notified by the resource management module 301 and can relinquish the abstracted interface at a later time.

In an example embodiment, clients may be assigned a priority. In this example, priority is allocated based at least in part on the importance of a particular client operation and is used by the resource management module 301 to determine access to resources. For example, a telephony server, which manages phone calls, is given a high priority, as initiating or receiving a phone call is one of the most important features a mobile device is responsible for. In an example embodiment, a multimedia player may be assigned a relatively low priority as play-back of audio or video is not particularly important (relative to initiating a phone call). In the present example, the resource management module 301 is arranged to use a five level priority system. In this example, level five priority is the highest priority. This level may assigned to a telephony server. In this example, the lowest level is level one. In an example embodiment, it will be appreciated that the software developer may decide which priorities to assign to different clients based on the overall number of clients and their relative importance. In other examples, different priority systems may be used, including a binary priority system. In this example, where two competing clients have the same priority level, the client which made a request for resources most recently takes precedent over the client which made a request earlier. In this example, therefore, if a new client requests a resource which is being used by another client of the same priority, the new client will be granted access to the resource. As an alternative example, priorities may be assigned automatically.

In an example embodiment, the resource management module 301 enforces weakened ownership of resources. In this example, lower priority clients ultimately yield to higher priority clients. In this example, this means that new use cases can start without having to wait for old use cases to release a resource. This may be advantageous in this example of the mobile phone environment where resource stealing and interruption in the multimedia sub-system can occur frequently. Where a resource may be contested (e.g. more than one client requires the resource at a given time) indirect access may be preferable. In certain examples, this means that high priority clients can gain immediate access to the resource. In certain examples, on a mobile phone, where phone calls and multimedia functions share resources, this may be particularly important.

In the example shown in FIG. 4 client A 204 has priority level five and client B 205 has priority level four. In the following example of the operation of the mobile device 101, the client B 205 is already using resource A 207, via abstracted interface B-A 210. In this example, access to resource A 207 has been previously granted by the resource management module 301. In this example, the resource management module 301 knows, therefore, that resource A 207 is currently being accessed by client B 205 at priority level four.

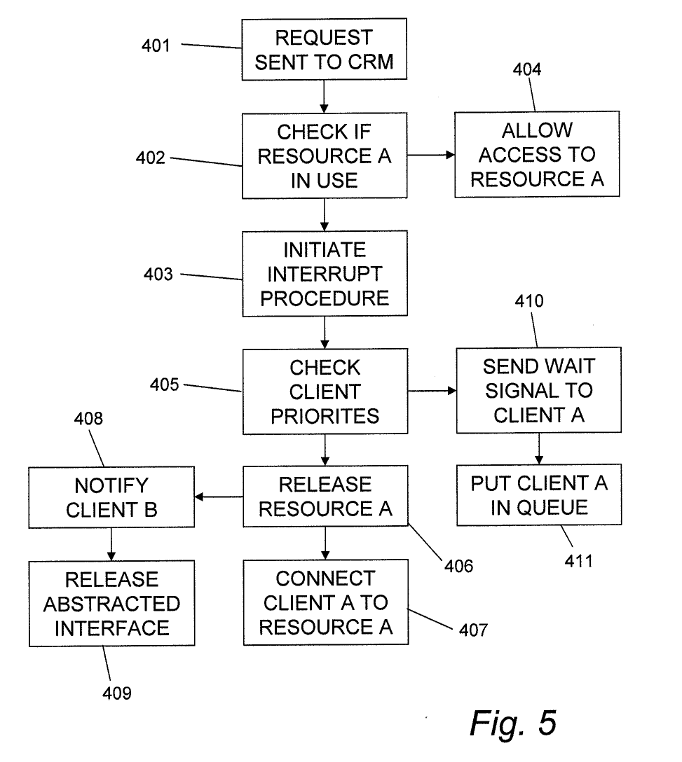

FIG. 5 is a flow diagram showing the mechanism by which access may be gained to resource A 207, by client A 204 in an example embodiment. In this example, when client A 204 requires the resource A 207, it sends a request to the resource management module 301 (block 401). In this example, the resource management module 301 initially checks to see if resource A 207 is in use (block 402). In this example, resource A 207 is in use and the resource management module 301 runs an interruption procedure (block 403). In this example, if the resource A 207 was not in use, the resource management module 301 would allow the client A 204 to access resource A 207 (block 404). In this example, having begun the interruption procedure, the resource management module 301 checks the priority of the client A 204 against the priority of client B 205 (block 405). In this example, as client A 204 is of a higher priority than the client B 205, the resource management module 301 releases resource A 207 from the abstracted interface B-A 210 (block 406). In this example, the resource management module initiates abstracted interface A-A 211 (see FIG. 4) and allows client A 204 to connect to resource A 207 via the abstracted interface A-A 211 (block 407). In this example, simultaneously, the resource management module 301 notifies client B 205 that resource A 207 is about to be removed (block 408). In this example, client B 205 still thinks it is using resource A 207 although it is actually just using the abstracted interface B-A 210. Client B 205 takes the necessary action to relinquish the abstract interface (block 409).

In an example embodiment, if the resource management module 301 determines that Client A 204 is of a lower priority than the Client B 205 at block 405, it sends a “wait” signal (block 410) to Client A 204. In this example, the resource management module 301 puts Client A 204 in a queue (block 411). In this example, client A can decide (based on a pre-programmed algorithm) whether to give-up and notify the user or wait for the resource to become available. In an alternative example, Client A 204, may give this option to a user of the device.

In the above-described example, clients connect to resources through abstracted interfaces and access is controlled by the resource management module 301. As noted in the above examples, these connections are indirect connections. In certain examples, the resource management module 301 is able to remove a resource from a client immediately, and without warning, if the connection is indirect. In certain examples, the resource management module 301 can do this if the priority of the client making the incoming request is of a higher priority than the exiting client. In certain examples, the resource management module 301 is therefore pre-emptive. That is, it is able to interrupt an existing process, providing certain conditions are met.

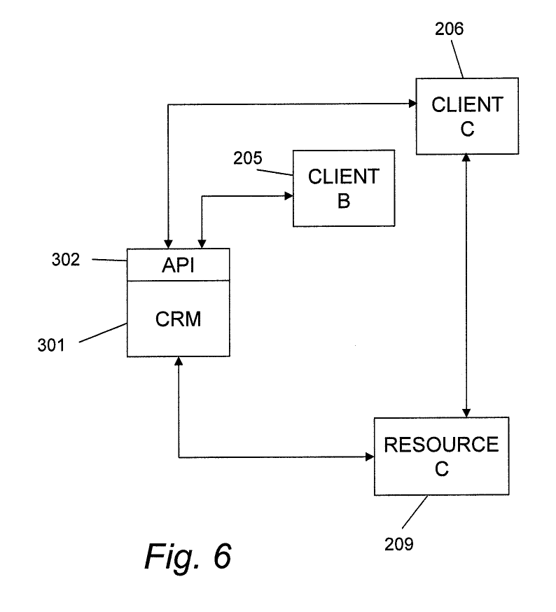

In a further example of the present invention, clients may have direct access to certain resources in addition to the indirect access described above. An example embodiment is shown in FIG. 6. In this example, when a client accesses a resource directly, no abstracted interface is required. In the example of FIG. 6, the resource management module 301 still controls access to resources, but clients access the resources directly. In this example, the resource management module 301 informs a client that it must relinquish a resource, when a request is received from a higher priority client. In the example of FIG. 6, client C 206 is shown having direct access to resource C 209. In this example, the client C 206 also communicates with the resource management module 301 so that the resource management module 301 knows which clients are accessing which resources. In this example, FIG. 6 also shows a client B 205.

In this example, resources which are accessed directly cannot be relinquished immediately. In this example, when a higher priority client wishes to use a resource which is being accessed directly, the existing client is notified by the resource management module 301. In this example, the existing client is given a limited time in which to relinquish the resource. In this example, it is the higher priority client which is ultimately able to gain access to the resource. In this example, it is preferred that direct access is only used for un-contested resources.

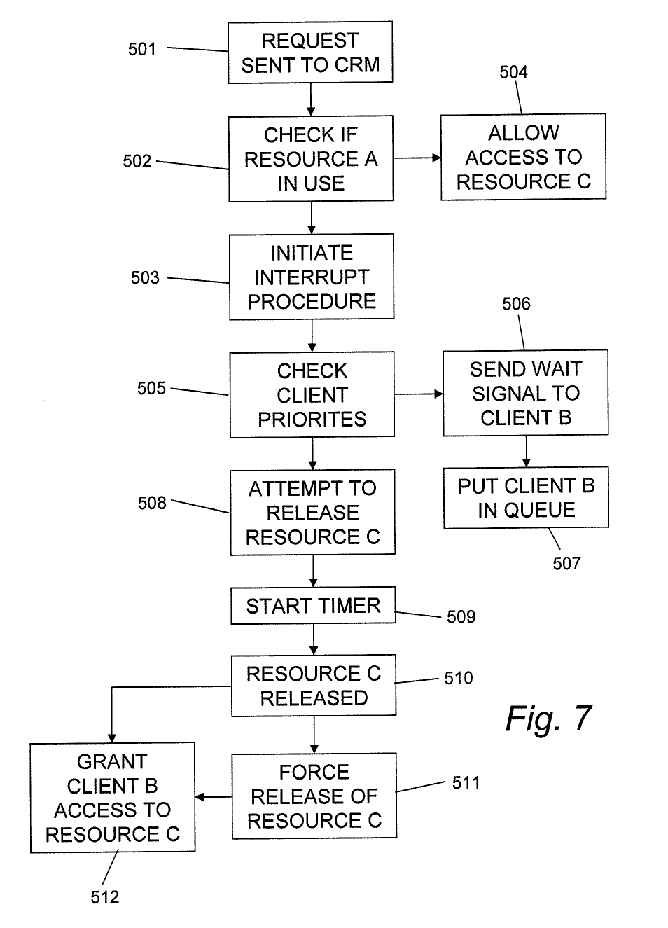

FIG. 7 shows the process of direct resource access in accordance with this example. In this example, when client B 205 wishes to gain access to resource C 209, a request is made to the resource management module 301 via the API 302 (block 501). In this example, the resource management module 301 checks to see if resource C 209 is in use (block 502). In this example, resource C 209 is in use and the resource management module 301 runs an interruption procedure (block 503). In this example, if resource C 209 was not in use, the resource management module 301 would allow client B 205 to access resource C 209 (block 504). In this example, the resource management module 301 compares the priority of client C 206 with the priority of client B 205 (block 505). In this example, the resource management module 301 establishes that client B 205 is of a higher priority than client C 206. In another example, if the resource management module 301 determined that client B 205 was of lower priority than client C 206, client B would be sent a “wait” signal (block 506). In this example, the resource management module 301 puts Client B 205 in a queue (block 507). In this example, client B can decide (based on a pre-programmed algorithm) whether to give-up and notify the user or wait for the resource to become available. In an alternative example, Client B 205, may give this option to a user of the device.

In the present example, the resource management module 301 notifies client C 206 that it must relinquish resource C 209 (block 508). In this example, the resource management module 301 starts a timer (block 509), which may be, for example, 1 second. In this example, the resource management module 301 waits until the timer has expired. In this example, at that point, the resource management module 301 determines whether or not client C 206 has relinquished resource C 209 (block 510). In this example, if client C 206 has not relinquished resource C 209, the resource management module 301 may force client C 206 to relinquish resource C (block 511). In an alternative example, if client C has relinquished resource C 209 itself, within the 1 second time-period, no action is taken by the resource management module 301. In this example, the resource management module 301 instructs client B 205 to connect to resource C 209 (block 512).

Where a resource is not contested (or is unlikely to be contested), direct access may be used, as described in the above example. For example, a particular client may be operating under a particular use-case. That use case may require access to various resources. In this example, some of those resources may be accessed indirectly, while others may be accessed directly. In this example, if the directly accessed resource is uncontested, the existing client may be allowed to continue accessing it when a higher priority client requires access to some of the indirectly accessed resources. In this example, direct access is allowed to certain, uncontested resources, in combination with indirect access to contested resouces.

In the above-described example, clients have a weakened notion of ownership of resources. In certain examples, indirect access via an interface provides a more robust environment in which to force clients to give up resources. In certain examples, direct access provides certain guarantees to a client. For example, the client may not be forced to give up the resource without notice. However, in certain examples, the client should give up that resource within a particular time period.

Whether or not a resource is accessed indirectly or directly is largely client dependent. In certain examples, a particular resource may be accessed directly by one client, but indirectly by another client. In certain examples, if the new use case is a high priority one, the resource management module 301 will deal with the existing client in the manner described above, depending on whether it is accessing the resource directly or indirectly. In certain examples, once the resource is available, the new, high priority client will access the resource.

The above examples of the invention describe a software implementation of the invention. Other examples of the invention include a hardware only implementation and a combined hardware and software implementation. An example of the invention includes a component on a chip which provides the functionality described above in connection with the software implementation.

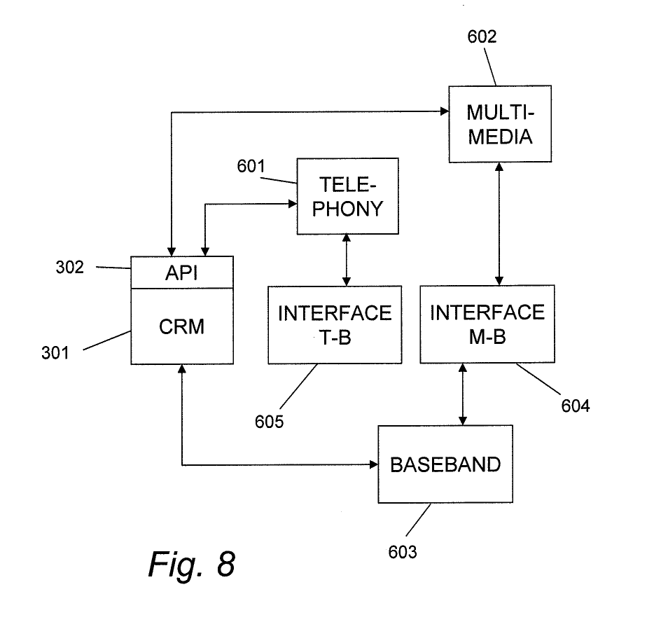

FIG. 8 shows a further example of the invention. This example is similar to that shown in FIG. 4, in that it relates to indirect access. In this example, FIG. 8 is a functional diagram of certain components of the mobile device 101. In this example, the device 101 includes the resource management module 301. In this example, the resource management module 301 is capable of direct control over certain resources. FIG. 8 shows telephony server 601 and a multimedia player 602, in an example embodiment. In this example, each client is capable of two-way communication with the resource management module 301. In this example, the resource management module 301 includes an Application Programming Interface (API) 302. In this example, access to the resource management module 301 is provided through the API 302. In this example, if a client wishes to access a resource, it may do so by first requesting access from the resource management module 301. FIG. 8 also shows baseband processor 603. In the example of FIG. 8, multimedia player 602 is shown accessing the baseband processor 603 through abstracted interface M-B 604. In this example, although not yet instantiated, the telephony server 601 will access the baseband processor through abstracted interface T-B 605.

In the example shown in FIG. 8 telephony server 601 has priority level five and multimedia player 602 has priority level four. In the following example of the operation of the mobile device 101, the multimedia player 602 is already using baseband processor 603, for example to stream video to the handset 201, via abstracted interface M-B 604. In this example, access to baseband processor 603 has been previously granted by the resource management module 301. In this example, the resource management module 301 knows, therefore, that baseband processor 603 is currently being accessed by multimedia player 602 at priority level four.

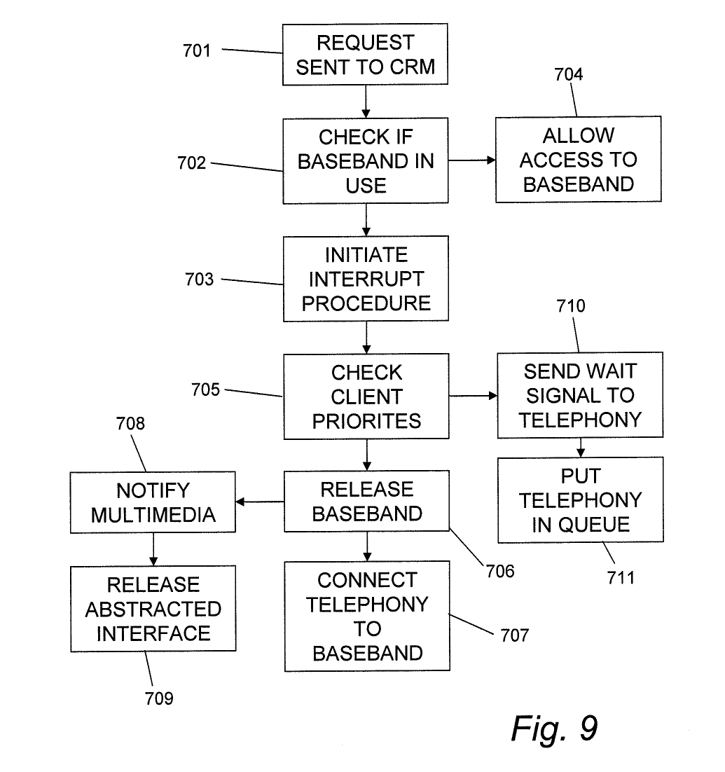

FIG. 9 is a flow diagram showing the mechanism by which access may be gained to baseband processor 603, by telephony server 601 in an example embodiment. In this example, when telephony server 601 requires the baseband processor 603, it sends a request to the resource management module 301 (block 701). In this example, the resource management module 301 initially checks to see if baseband processor 603 is in use (block 702). In this example, baseband processor 603 is in use and the resource management module 301 runs an interruption procedure (block 703). In this example, if the baseband processor 603 was not in use, the resource management module 301 would allow the telephony server 601 to access baseband processor 603 (block 704). In this example, having begun the interruption procedure, the resource management module 301 checks the priority of the telephony server 601 against the priority of multimedia player 602 (block 705). In this example, as telephony server 601 is of a higher priority than the multimedia player 602, the resource management module 301 releases baseband processor 603 from the abstracted interface M-B 604 (block 706). In this example, the resource management module initiates abstracted interface T-B 605 (see FIG. 8) and allows telephony server 601 to connect to baseband processor 603 via the abstracted interface T-B 605 (block 707). In this example, simultaneously, the resource management module 301 notifies multimedia player 602 that baseband processor 603 is about to be removed (block 708). In this example, multimedia player 602 still thinks it is using baseband processor 603 although it is actually just using the abstracted interface M-B 604. Multimedia player 602 takes the necessary action to relinquish the abstract interface (block 709).

In an example embodiment, if the resource management module 301 determines that telephony server 601 is of a lower priority than the Multimedia player 602 at block 705, it sends a “wait” signal (block 710) to telephony server 601. In this example, the resource management module 301 puts telephony server 601 in a queue (block 711). In this example, the telephony server 601 can decide (based on a pre-programmed algorithm) whether to give-up and notify the user or wait for the resource to become available. In an alternative example, telephony server 601, may give this option to a user of the device.

In an example embodiment of the invention, the clients and resources may be multimedia components. An advantage of this example is that multimedia components may use a lot of resources and may retain resources for long periods of time. A client may be a software application or hardware. For example, a client may be a telephony server, which is arranged to manage telephone calls. A client may also be a multimedia player. For example, the telephony server may be of a higher priority than the multimedia player, as, for a mobile phone, telephone calls are more important than viewing multimedia content.

In example embodiments, a resource may be any software or hardware based computing resource. For example, a hardware resource may be processor time, shared memory, bandwidth etc. In a further example, a software resource may be a communications channel, a CODEC, a resource controller etc.

An example of the invention is an apparatus as defined in the claims. This apparatus may be a component provided as part of a chip on an electronic circuit board. Alternatively the apparatus may be a chip on an electronic circuit board. As a further alternative, the apparatus may be a computing device, such as a mobile phone. The features defined in the claims may be implemented in hardware. Alternatively, the features may be implemented using software instructions which may be stored in a memory provided on the component, chip or computing device.

A further example of the invention provides an apparatus comprising: means for controlling access to one or more resources, by one or more clients; means for receiving a request for access to a said resource from a first client, means for determining whether or not said resource is being used by a second client, and, if said resource is being used, remove said resource from said second client and provide said resource to said first client. In an example embodiment, the means for controlling may be a processor which may provided as a component on an electronic circuit board.

In an example embodiment, there is provided an apparatus substantially as described hereinbefore and as shown in FIGS. 1 to 9.

In an example of the invention, the resource control module is a software module stored in a memory of the mobile device. As an alternative, the resource control module may be a hardware module provided as a component on a circuit board for use in such a mobile device.

Examples of the present invention may be implemented in software, hardware, application logic or a combination of software, hardware and application logic. The software, application logic and/or hardware may reside on an individual component, computer chip or other computing apparatus. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 1. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

Various modifications, changes, and/or alterations may be made to the above described examples to provide further examples which use the underlying inventive concept, falling within the spirit and/or scope of the invention. Any such further examples are intended to be encompassed by the appended claims.

1. An apparatus comprising:
at least one processor; and
at least one memory including computer program code, the at least one memory and the computer program code configured to, with the at least one processor, cause the apparatus at least to:
control access to one or more resources, by one or more clients;
receive a request for access to a resource from a first client;
determine whether or not said resource is being used by a second client; and
in response to said resource being used, remove said resource from said second client and provide said resource to said first client.

2. An apparatus according to claim 1, wherein the at least one memory and the computer program code are further configured to, with the at least one processor, cause the apparatus to:
determine if a first condition is met, and to remove said resource from the second client if said first condition is met.

3. An apparatus according to claim 2, wherein the at least one memory and the computer program code are further configured to, with the at least one processor, cause the apparatus to:
compare a priority of a said first client with a priority of the second, wherein said condition is met if the priority of the first client is at least as great as the priority of the second client.

4. An apparatus according to claim 1, wherein said resource is accessed via an interface, and the at least one memory and the computer program code are further configured to, with the at least one processor, cause the apparatus to:
remove said resource from said interface between the second client and the resource

5. An apparatus according to claim 4, wherein the at least one memory and the computer program code are further configured to, with the at least one processor, cause the apparatus to:
allow said second client to continue to use the interface, after said resource has been removed.

6. An apparatus according to claim 5, wherein the at least one memory and the computer program code are further configured to, with the at least one processor, cause the apparatus to:
notify the second client that the interface should be relinquished.

7. An apparatus according to claim 4, wherein the at least one memory and the computer program code are further configured to, with the at least one processor, cause the apparatus to:
notify the second client that it should relinquish the resource.

8. An apparatus according to claim 7, wherein the at least one memory and the computer program code are further configured to, with the at least one processor, cause the apparatus to:
start a timer at the time of notification and at the end of a first time period, remove the resource from the second client, if the second client has not relinquished the resource.

9. An apparatus according to claim 1, wherein the at least one memory and the computer program code are further configured to, with the at least one processor, cause the apparatus to:
establish a resource management module which is configured to cause the apparatus to operate as described in any preceding claim.

10. A computing device comprising the apparatus of claim 1.

11. A computing device according to claim 10, wherein said device is a mobile phone.

12. A method comprising:
receiving a request from a first client for access to a resource of a computing device;
determining if said resource is being used by a second client;
removing said resource from said second client in response to said resource being used; and
providing said resource to said first client.

13. A method according to claim 13, wherein removing said resource further comprises determining if a first condition is met, and removing said resource if said first condition is met.

14. A method according to claim 14, wherein removing said resource further comprises comparing a priority of a said first client with a priority of the second, wherein said condition is met if the priority of the first client is at least as great as the priority of the second client.

15. A method according to claim 13, wherein removing said resource further comprises removing said resource from an interface between the second client and the resource.

16. A method according to claim 16, wherein removing said resource further comprises notifying the second client that the interface should be relinquished.

17. A method according to claim 12, wherein removing said resource further comprises notifying the second client that it should relinquish the resource.

18. A method according to claim 17, wherein removing said resource further comprises starting a timer at the time of notification and at the end of a first time period, removing the resource from the second client, if the second client has not relinquished the resource.

19. A computer program product comprising a computer-readable medium bearing computer program code embodied therein for use with a computer, the computer program code comprising:
code for receiving a request from a first client for access to a resource of a computing device;
code for determining if said resource is being used by a second client;
code for removing said resource from said second client in response to said resource being used; and
code for providing said resource to said first client.
